(19) United States
(12) Patent Application Publication
(10) Pub. No.: US 2003/0036977 A1
(43) Pub. Date: Feb. 20, 2003

(54) Order and inventory information management system

(76) Inventor: Kevin C. Morse, Flint, MI (US)

Correspondence Address: HARSHAW RESEARCH INCORPORATED, P O BOX 418, OTTAWA, KS, 66067, US

(21) Appl. No.: 09/929,785

(22) Filed: Aug. 14, 2001

(51) Int. Cl. G06F 17/60

(52) U.S. Cl. 705/27; 705/28

(57) ABSTRACT

An order and inventory management system includes a hand-held data entry terminal having a display and input buttons. The display shows table and seat locations and a restaurant menu. The input buttons enable a waiter to select a table and seat location and to select food items ordered by a patron at the selected location. The order is transmitted to a remote host computer where it is routed to respective food and drink terminals for order fulfillment and to a billing terminal for bill printing. The host computer includes a database having a plurality of product records, each record having a menu price, inventory quantity, and vendor identifier associated with a respective restaurant product. Upon receipt of an order, the host computer modifies the quantity of ordered products and automatically delivers a signal to a respective vendor via a network connection to order an additional quantity, if necessary.

### BACKGROUND OF THE INVENTION

This invention relates generally to restaurant information and order management systems and, more particularly, to an electronic order and inventory information management system for managing restaurant operations.

Restaurants continually desire to enhance the speed, accuracy, and efficiency of order taking, routing, and fulfillment. Increased speed and efficiency results in faster meal completion and customer turnover which, consequently, results in greater revenue. Increased accuracy contributes to efficiency and, more importantly, to customer satisfaction.

Various systems have been proposed in the art for improving the routing and accurate fulfillment of food orders in a restaurant environment. Other systems are directed to maintaining an accurate electronic record of present inventory. Although assumably effective for their intended purposes, existing systems do not track and route a particular patron's order for efficient fulfillment thereof while also tracking corresponding inventory changes and automatically electronically ordering additional quantities of a respective product as needed.

Therefore, it is desirable to have an electronic order and inventory information management system which tracks and routes a particular patron's order for efficient fulfillment thereof as well as tracking corresponding inventory changes, and which also automatically orders additional quantities of a respective product whose inventory quantity has fallen below a predetermined quantity.

### SUMMARY OF THE INVENTION

An electronic order and inventory information management system according to the present invention includes a plurality of portable hand-held data entry terminals. Each data entry terminal is designed to be carried by a waiter or waitress in a restaurant and each terminal includes a display as well as a keypad and data selection input buttons. Each data entry terminal is adapted to display the layout of tables and specific seat locations at those tables as well as the restaurant menu. A waiter is able to input a specific seat location of a patron whose order he is taking and to input the specific food or drink items ordered by the patron. Each data entry terminal includes a transmitter for transmitting these selections.

The system further includes a host computer having a receiver for receiving the transmitted order information. The host computer includes a database having a plurality of product records, each record being associated with a particular menu item and having data elements indicative of a menu sales price, a present inventory quantity, and a vendor identifier. When the host computer receives transmitted order information, the computer identifies the respective product record associated with each menu item ordered and causes the inventory quantity of each respective record to be decremented. If this operation causes a respective inventory quantity to be less than a predetermined quantity, then a re-order operation is initiated. The host computer is connected to a wide area computer network (e.g. the Internet) as are respective vendor computers. According to a respective vendor identifier in the relevant product record, the host computer delivers a signal to the respective vendor computer which indicates an order for an additional quantity of the respective product. Thus, the present system avoids inventory ordering delays that are typical in restaurant management.

The host computer is also electrically connected to a food terminal, drink terminal, and billing terminal with a local area computer network. Thus, transmitted order information received by the host computer is disassembled and routed to appropriate terminals for order fulfillment and bill printing. The food and drink terminals include displays and input means such that messages verifying order fulfillment may be delivered back to the host computer.

Therefore, a general object of this invention is to provide an information system for managing order and inventory information in a restaurant environment.

Another object of this invention is to provide an information system, as aforesaid, which enables food and drink orders to be selected and input into a hand-held data entry terminal and then transmitted to a remote host computer.

Yet another object of this invention is to provide an information system, as aforesaid, in which respective portions of transmitted order information may be routed to food and drink terminals for order fulfillment.

A further object of this invention is to provide an information system, as aforesaid, in which the host computer automatically electronically orders additional quantities of menu items from an on-line vendor computer when the quantity thereof is less than a predetermined quantity.

A still further object of this invention is to provide an information system, as aforesaid, in which each data entry terminal includes controls for selecting particular display screens, for selecting patron seating locations, and for selecting food and drink orders.

A particular object of this invention is to provide an information system, as aforesaid, in which each data entry terminal includes a handle and forearm support member such that the terminal may rest on a waiter's forearm and be held securely in one hand.

Other objects and advantages of this invention will become apparent from the following description taken in connection with the accompanying drawings, wherein is set forth by way of illustration and example, an embodiment of this invention.

### BRIEF DESCRIPTION OF THE DRAWINGS

FIG. 1 is a perspective view of a order and inventory information management system in use in a restaurant environment;

FIG. 2 is a front perspective view of a data entry terminal on an enlarged scale as shown in FIG. 1;

FIG. 3 is rear perspective view of the data entry terminal as in FIG. 2;

FIG. 4 is a block diagram of the information management system as in FIG. 1;

FIG. 5 is a flow chart illustrating the logic performed by the information management system as in FIG. 4; and

FIG. 6 is a block diagram showing the internal components of a data entry terminal.

### DESCRIPTION OF THE PREFERRED EMBODIMENT

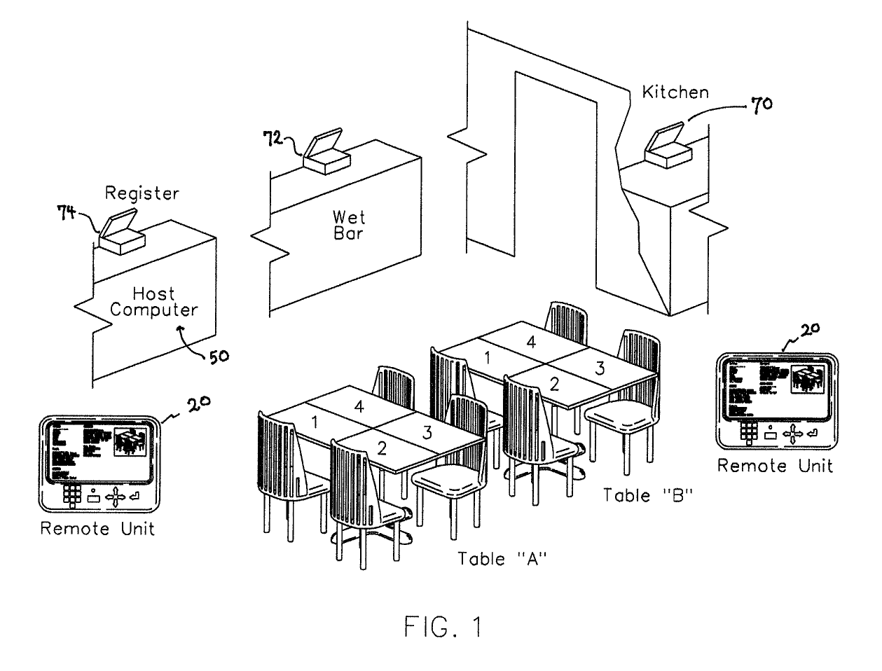

An electronic order and inventory information management system 10 for management of a restaurant according to a preferred embodiment of the present invention will now be described in detail with reference to FIGS. 1 through 6 of the accompanying drawings.

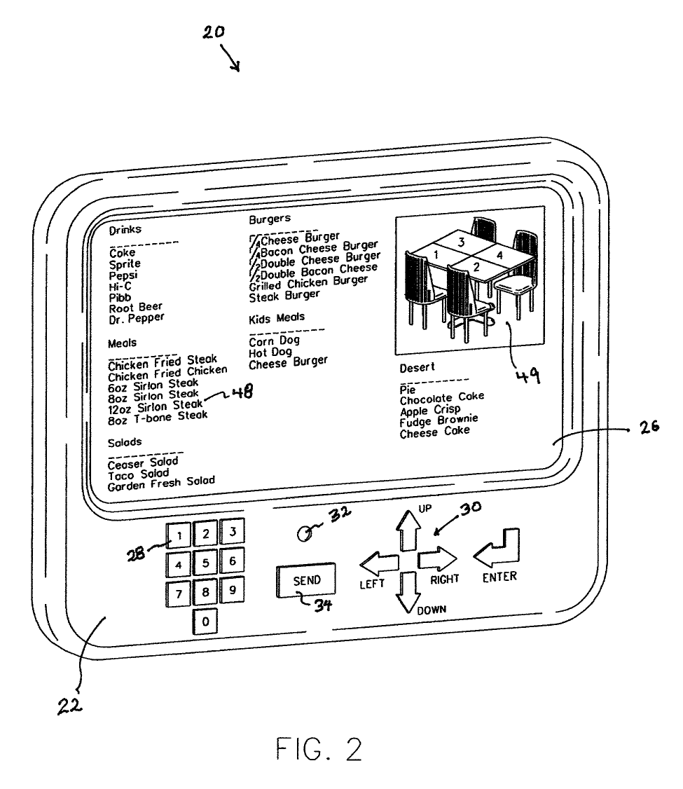

The information management system 10 includes a plurality of portable, hand-held data entry terminals 20 (FIG. 2). Each data entry terminal 20 includes a generally rectangular housing having a front side 22 connected to a rear side 24, the sides defining a thin interior space therebetween. A display 26 is positioned on the front side 22 of each data entry terminal 20. A keypad 28 and selector buttons 30 are also positioned on the front side 22. Of course, a stylus, plastic pointer, or touch screen would also be suitable input means. A low battery LED 32 and a “Send” button 34 are also positioned on the front side 22, as to be described more fully below. It is contemplated that a data entry terminal 20 could be electrically connected to a backup power source while an old battery is exchanged with a new battery.

A battery 36 is positioned within the interior space of the data entry terminal housing (FIG. 6). A transceiver 38 is also mounted therein and is electrically connected to the battery 36. A programmable logic circuit “PLC” 40 is also positioned within the interior space of the data entry terminal housing and is connected to the battery 36. The PLC 40 includes a memory having graphical representations of the table layout within the restaurant and of each individual table 49 including specific seat locations. The PLC 40 further includes a listing of the restaurant menu 48. The menu 48 may be displayed immediately adjacent the graphical representation 49 of a selected table and seat location (FIG. 2). It is understood that the PLC 40 may be programmed or re-programmed by restaurant management as needed. The PLC is electrically connected to the selector buttons 30 such that a waiter is able to select an appropriate table identifier, seat location, and specific menu items ordered by a particular patron. By pressing the “Send” button 34, this order information is transmitted through the air by the transceiver 38 for processing, as to be described more fully below.

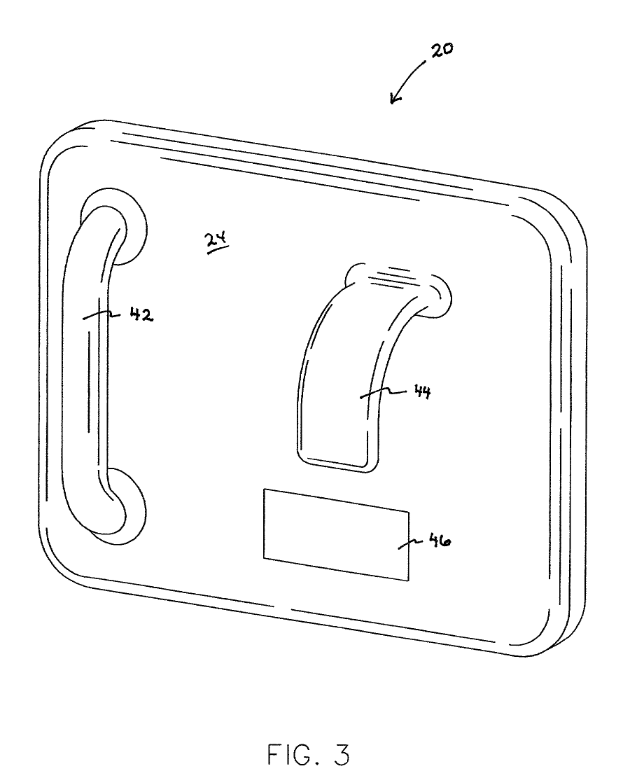

A handle 42 is fixedly attached to the rear wall 24 of each data entry terminal 20 (FIG. 3). The handle 42 is positioned longitudinally between upper and lower housing edges. A support member 44 is fixedly attached to the rear wall 24 and spaced from the handle 42, the support member 44 having a generally arcuate configuration with a lower end displaced from the rear wall 24. The support member 44 is configured to rest and be supported upon a wrist or forearm of a waiter. The rear wall 24 of each data entry terminal 20 further includes a battery access door 46 that may be selectively removed for replacing the terminal battery 36.

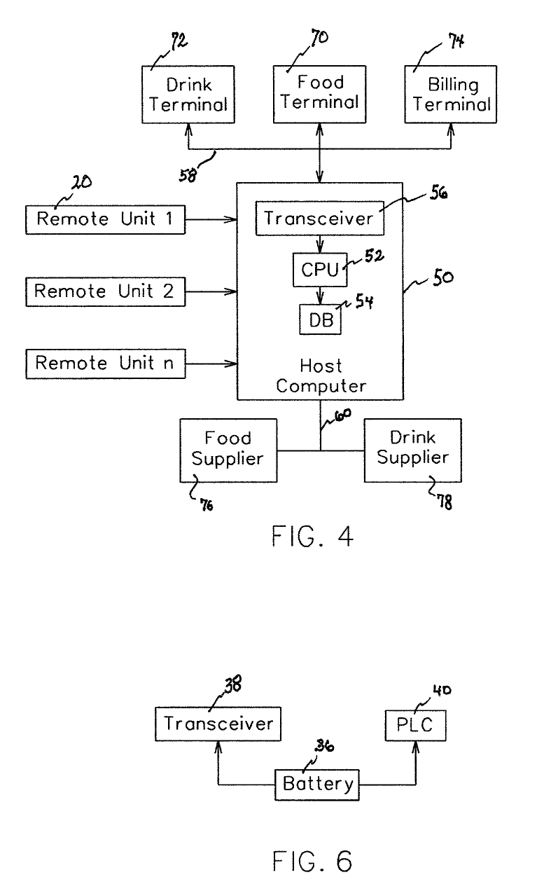

The system 10 further includes a host computer 50 (FIG. 4). The host computer 50 includes a central processing unit (“CPU”)52 and a memory. The host computer CPU 52 is connected to a database 54, the database preferably being stored in the host computer memory. The database 54 includes a plurality of product records with each record being associated with a restaurant menu item. Each record includes data fields indicative of at least a menu selling price of a respective food or drink item, a present inventory quantity of that item, and a vendor identifier that identifies an on-line source of the respective menu item. The host computer 50 includes circuitry for connection to a wide area computer network (“WAN”) 60 such as the Internet. Participating food and drink suppliers 76, 78 have computers connected to the Internet as well so that the host computer 50 may send signals indicative of product orders to those computers.

The host computer 50 further includes a transceiver 56 adapted to receive order information transmitted by a data entry terminal 20 (FIG. 4). The transceiver 56 is electrically connected to the CPU 52 which includes circuitry to parse and separate the order information into food order and drink order portions. The host computer 50 further includes network circuitry to establish a local area computer network (“LAN”) 58 between the host computer 50 and a food terminal 70, drink terminal 72, and billing terminal 74. The food terminal 70 and drink terminal 72 each include a display and conventional input means. The food order portion of the order information is delivered to the food terminal 70 along the LAN 58 and is displayed on the food terminal display so that restaurant personnel can fulfill the order. The drink order portion of the order information is delivered in like manner to the drink terminal display. The food and drink terminals include circuitry to deliver messages, such as order fulfillment verifications, back to the host computer 50. The host computer 50, in turn, may transmit these messages to the appropriate data entry terminal 20. Upon receiving transmitted order information, the host computer 50 may access corresponding product records so as to determine the associated menu prices. These prices may then be delivered to the billing terminal 74 via the LAN 58 where a bill may be printed for delivery to a respective patron.

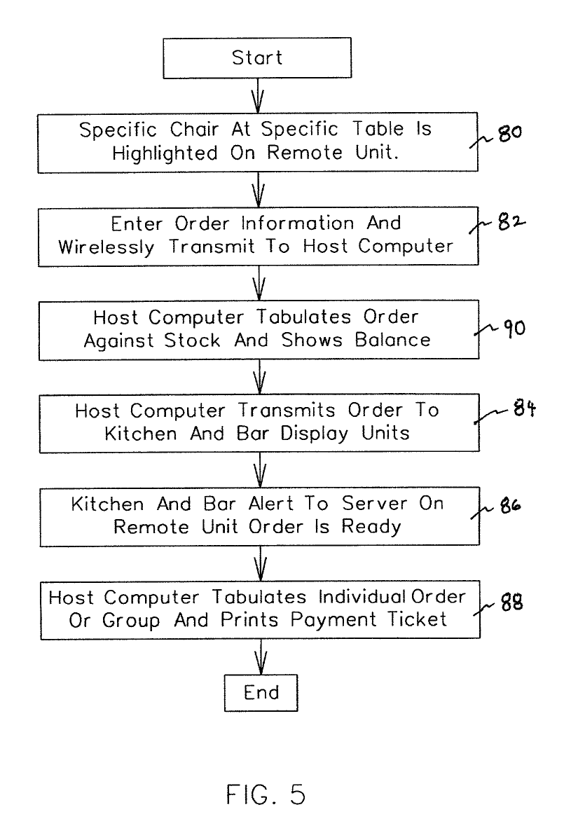

In use, each PLC 40 in a data entry terminal 20 includes a mode that allows restaurant management to determine table layout and menu selections. When a data entry terminal 20 is powered up, it may display the table layout of the restaurant although a waiter may use the selector buttons 30 to limit the display to the tables for which he is responsible. When waiting tables, a waiter may hold the data entry terminal 20 by grasping the handle 42 and allowing the support member 44 to rest upon his wrist or forearm. When the waiter has selected the patron's table, a single table graphic representation is displayed showing the specific seat locations (FIG. 2). A menu 48 is displayed on the display 26 adjacent to the single table graphic. The specific patron seat location and menu items ordered by the patron may then be selected using the selector buttons 30, as indicated at blocks 80 and 82 in FIG. 5. These selections are associated together by the PLC 40 and may be transmitted as “order information” when the waiter pushes the “Send” button 34, as indicated at block 84.

The host computer transceiver 56 receives the order information and the CPU 52 parses and separates it into food, drink, and billing portions. The food and drink portions are delivered via the LAN 58 to the food terminal 70 and drink terminal 72 for display and order fulfillment. Table and seat location identifiers are also displayed so that the food and drink orders may be delivered to the proper seating locations during order fulfillment. Or, the terminals may send messages back to the host computer 50 and then to respective data entry terminals 20 that an order is ready to be served, as in block 86. The host computer CPU 52 associates the order information with respective product records stored in the database 54. The billing portion is delivered to the billing terminal 74 where a bill or receipt is printed 88. Further, the inventory quantity data element of respective product records corresponding to ordered menu items is decremented so as to maintain accurate inventory records, as indicated at block 90. If the inventory quantity of a respective record is less than a predetermined quantity, then the host computer 50 initiates a signal to the computer of a food or drink supplier 76, 78 connected to the wide area network so as to automatically order additional quantity of that product (FIG. 4).

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. An electronic order and inventory information management system for use in managing a restaurant, comprising:
a portable hand-held data entry terminal having a display and having means for inputting restaurant order information, said data entry terminal having a transceiver for transmitting said order information;
a database having a plurality of product records associated with products offered for sale at the restaurant, each product record including at least a menu selling price, a present inventory quantity, and an identifier associated with a vendor;
a host computer having a transceiver for receiving said transmitted order information, said host computer being electrically connected to said database and to a wide-area computer network;
means in said host computer for decrementing a respective inventory quantity of a respective product record corresponding to a respective product when said respective product is included in said transmitted order information; and
means in said host computer for transmitting a signal along said wide-area computer network to a vendor computer corresponding to a respective vendor identifier when said respective inventory quantity is less than a predetermined quantity, said signal being indicative of an order for an additional quantity of said respective product.

2. The order and inventory information management system as in claim 1 wherein said host computer includes network circuitry for establishing a local area network between said host computer and remote network terminals;
said order and inventory information management system further comprising:
a kitchen terminal electrically connected to said local area network and having a display for displaying a portion of said transmitted order information pertaining to a food order, said kitchen terminal adapted to transmit messages back to said host computer indicative of fulfillment of said food order;
a drink terminal electrically connected to said local area network and having a display for displaying a portion of said transmitted order information pertaining to a drink order, said drink terminal adapted to transmit messages back to said host computer indicative of fulfillment of said drink order.

3. The order and inventory information management system as in claim 1 wherein said host computer includes means for associating said transmitted order information with respective menu selling prices from said database.

4. The order and inventory information management system as in claim 3 further comprising a billing terminal electrically connected to said local area network for receiving said transmitted order information and said associated menu selling prices, said billing terminal including means for calculating a total order sales amount and means for printing said transmitted order information and said total order sales amount.

5. The order and inventory information management system as in claim 1 wherein said order information includes at least one customer seating location identifier and at least one food selection associated with said at least one seating location identifier, said at least one food selection corresponding to a respective product record.

6. The order and inventory information management system as in claim 1 wherein said data entry terminal comprises:
a housing having front and back sides, said display positioned on said front side;
a handle fixedly attached to said back side of said housing and adapted to be gripped by a waiter's hand for holding said data entry terminal.

7. The order and inventory information management system as in claim 6 further comprising a support member fixedly attached to said back side of said housing and having a generally arcuate configuration adapted to rest upon a forearm of a waiter when holding said data entry terminal.

8. The order and inventory information management system as in claim 1 wherein said means for inputting restaurant order information comprises:
means for displaying on said display a graphical representation of a plurality of table locations and a plurality of seat locations associated with each table location;
means for displaying on said display a menu of food and drink items corresponding to said plurality of product records in said database; and
a keypad and a plurality of buttons on said data entry terminal adjacent said display adapted to enable a waiter to select a table and seat location of a patron whose order is being taken and to select respective food and drink items ordered by said patron.

9. The order and inventory information management system as in claim 8 further comprising means for displaying a graphical representation of a single table once a waiter has selected a table location of a patron whose order is being taken, said graphical representation of a single table being positioned adjacent said display of a menu of food items upon said display.

10. The order and inventory information management system as in claim 8 wherein said means for displaying a graphical representation of a plurality of table locations includes means for displaying only those table locations assigned to be served by a selected waiter.

11. An electronic order and inventory information management system for use in managing a restaurant, comprising:
a portable hand-held data entry terminal having a display and having means for inputting restaurant order information, said data entry terminal having a transceiver for transmitting said order information;
a database having a plurality of product records associated with products offered for sale at the restaurant, each product record including at least a menu selling price, a present inventory quantity, and an identifier associated with a vendor;
a host computer having a transceiver for receiving said transmitted order information, said host computer connected to said database and connected to a wide-area computer network;
means in said host computer for associating said transmitted order information with respective menu selling prices from said plurality of product records in said database;
means in said host computer for decrementing a respective inventory quantity of a respective product record corresponding to a respective product when said respective product is included in said transmitted order information;
means in said host computer for transmitting a signal along said wide-area network to a vendor computer corresponding to a respective vendor identifier when said respective inventory quantity is less than a predetermined quantity, said signal being indicative of an order for an additional quantity of said respective product;
and
wherein said host computer includes network circuitry for establishing a local area network between said host computer and remote network terminals positioned in the restaurant.

12. The order and inventory information management system as in claim 11 further comprising:
a kitchen terminal electrically connected to said local area network and having a display for displaying a portion of said transmitted order information pertaining to a food order, said kitchen terminal adapted to transmit messages back to said host computer indicative of fulfillment of said food order; and
a drink terminal electrically connected to said local area network and having a display for displaying a portion of said transmitted order information pertaining to a drink order, said drink terminal adapted to transmit messages back to said host computer indicative of fulfillment of said drink order.

13. The order and inventory information management system as in claim 11 further comprising a billing terminal electrically connected to said local area network for receiving said transmitted order information and said associated menu selling prices, said billing terminal including means for calculating a total order sales amount and means for printing said transmitted order information and said total order sales amount.

14. The order and inventory information management system as in claim 11 wherein said order information includes at least one customer seating location identifier and at least one food selection associated with said at least one seating location identifier, said at least one food selection corresponding to a respective product record.

15. The order and inventory information management system as in claim 11 wherein said data entry terminal comprises:
a housing having front and back sides, said display positioned on said front side;
a handle fixedly attached to said back side of said housing and adapted to be gripped by a waiter's hand for holding said data entry terminal; and
a support member fixedly attached to said back side of said housing and having a generally arcuate configuration adapted to rest upon a forearm of a waiter when holding said data entry terminal.

16. The order and inventory information management system as in claim 11 wherein said means for inputting restaurant order information comprises:
means for displaying on said display a graphical representation of a plurality of table locations and a plurality of seat locations associated with each table location;
means for displaying on said display a menu of food and drink items corresponding to said plurality of product records in said database; and
a keypad and a plurality of buttons on said data entry terminal adjacent said display adapted to enable a waiter to select a table and seat location of a patron whose 9 order is being taken and to select respective food and drink items ordered by said patron.

17. The order and inventory information management system as in claim 16 further comprising means for displaying a graphical representation of a single table once a waiter has selected a table location of a patron whose order is being taken, said graphical representation of a single table being positioned adjacent said display of a menu of food items upon said display.

18. An electronic order and inventory information management system for use in managing a restaurant, comprising:
a portable hand-held data entry terminal having a housing with front and back sides and defining an interior space, said data entry device further comprising:
a display positioned on said front side;
means on said front side for inputting restaurant order information;
a transceiver positioned in said interior space for transmitting said order information;
a handle fixedly attached to said back side of said housing and adapted to be gripped by a waiter, whereby to hold said data entry unit;
a support member fixedly attached to said back side of said housing and having a generally arcuate support member adapted to rest upon an arm of a waiter when said waiter is holding said handle;
a database having a plurality of product records associated with food and drink products offered for sale at the restaurant, each product record including at least a menu selling price, a present inventory quantity, and an identifier associated with a vendor;
a host computer having a transceiver for receiving said transmitted order information, said host computer including network circuitry for establishing a local area network between said host computer and remote network terminals;
a kitchen terminal electrically connected to said local area network and having a display for displaying a portion of said transmitted order information pertaining to a food order, said kitchen terminal adapted to transmit messages back to said host computer indicative of fulfillment of said food order;
a drink terminal electrically connected to said local area network and having a display for displaying a portion of said transmitted order information pertaining to a drink order, said drink terminal adapted to transmit messages back to said host computer indicative of fulfillment of said drink order; and
means in said host computer for decrementing a respective inventory quantity of a respective product record corresponding to a respective product when said respective product is included in said transmitted order information.

19. The order and inventory information management system as in claim 18 wherein said host computer is connected to a wide-area network;
said order and inventory information management system further comprising means in said host computer for transmitting a signal along said wide-area network to a vendor computer corresponding to a respective vendor identifier when said respective inventory quantity is less than a predetermined quantity, said signal being indicative of an order for an additional quantity of said respective product.

20. The order and inventory information management system as in claim 18 wherein said means for inputting restaurant order information comprises:
means for displaying on said display a graphical representation of a plurality of table locations and a plurality of seat locations associated with each table location;
means for displaying on said display a menu of food and drink items corresponding to said plurality of product records in said database; and
a keypad and a plurality of buttons on said data entry terminal adjacent said display adapted to enable a waiter to select a table and seat location of a patron whose order is being taken and to select respective food and drink items ordered by said patron.
